(19) United States
(12) Patent Application Publication
(10) Pub. No.: US 2026/0267366 A1
(43) Pub. Date: Sep. 10, 2026

(54) METHOD FOR SENSING INDEPENDENT KNOB ACTIVATION USING A SINGLE OUTPUT SIGNAL

(71) Applicant: Haier US Appliance Solutions, Inc., Wilmington, DE (US)

(72) Inventors: Aaron Zarate-Hernandez, Louisville, KY (US); Tyler Patrick Barton, Clarksville, IN (US)

(21) Appl. No.: 19/070,608

(22) Filed: Mar. 5, 2025

(51) Int. Cl. G05G 1/015; F24C 3/12; F24C 7/08; H01H 19/14

(52) U.S. Cl. CPC G05G 1/015; F24C 3/126; F24C 7/083; H01H 19/14

(57) ABSTRACT

A method to detect individual knobs of a cooktop uses a knob activated switch that is connected in series with a 120 VAC source. When closed, the switch connects to a circuit using a Zener diode to clip the 120 VAC waveform per the Zener voltage of the diode, allowing different Zener voltages to create multiple unique waveforms corresponding to each knob input. The waveform from each Zener diode is conditioned to a lower voltage, and then sent through a positive or negative edge detection circuit. Only a single pulse is sent through when either a positive or negative edge of the waveform occurs. A zero cross circuit enables knowing which pulses correspond with which knob, to permit simultaneously reading plural independent signals on a single signal input.

### FIELD

Example aspects of the present disclosure relate generally to cooktop systems used, for instance, in cooking appliances, and more particularly to detect an individual knob or knobs of a cooktop using a knob activated switch or switches that are connected in series with a relatively high level voltage source, such as 120 VAC source, and to provide the individual knob and/or switch detection through a single output signal.

### BACKGROUND

For appliances with a cooktop, there are many cases where it is desirable or necessary to know whether an individual burner is currently on or off, particularly if the burner or element is one of a plurality of burners or elements. One example would be when the state of the individual burners would desirably be displayed to a user via the appliance's user interface. Additionally, the burner state could be shared to the cloud, allowing the user to see which burners are currently on via an app.

Currently, cooktop products that utilize a single AC input detection for knob activity can only give feedback as to whether at least one knob is currently active. Such approach does not give information as to which burner is currently active or if multiple burners are active.

Further, having individual burner state information can be used for diagnostic purposes to see if the switch to the burner or the burner element itself has failed as well as enabling any special features for burner activity.

One attempt to solve such problem can have a separate, individual input on the machine or appliance control for each burner. However, such approach has a significant cost impact for all of the additional circuits and wire harnessing that would be required to effectively duplicate the detection scheme for each respective burner.

### SUMMARY

Aspects and advantages of embodiments of the present disclosure will be set forth in part in the following description, or can be learned from the description, or can be learned through practice of the embodiments.

The presently disclosed subject matter relates to method and corresponding apparatus for sensing independent knob activation using a single output signal. Stated another way, presently disclosed subject matter allows for sensing the state of independent knob inputs utilizing a single input signal from the associated knob (user input) harness. The knob harness would have limited circuitry located on each knob in order to manipulate the input signal in a presently disclosed way that allows a microcontroller to detect which specific burner is on utilizing a single input signal. This solution would be implemented within the harness, making it compatible with any control that uses AC input detection, which could be implemented in different types of cooktops regardless of the nature of the heating element, and which could be implemented in contexts other than cooktops specifically or appliances generally.

Some exemplary embodiments of the presently disclosed subject matter encompassing method and corresponding apparatus relate to detecting individual knobs of a cooktop using a knob activated switch that is connected in series with a voltage source, such as 120 VAC source. When closed, the switch connects to a circuit for example using a Zener diode to clip the 120 VAC waveform per the Zener voltage of the diode, allowing different Zener voltages to respectively create multiple unique waveforms corresponding respectively to each knob input. The waveform from each Zener diode is conditioned to a lower voltage, and then sent through a positive or negative edge detection circuit. Only a single pulse is sent through when either a positive or negative edge of the waveform occurs. A zero cross circuit enables knowing which pulses correspond with which knob, to permit simultaneously reading plural independent signals on a single signal input.

Some exemplary embodiments herewith may comprise in part one or more processors programmed for performing corresponding steps and functions otherwise described for various embodiments herewith.

One example aspect of the present disclosure is directed to a method for detecting the respective positions of a plurality of individual knobs of a cooktop, which plurality of individual knobs are operatively associated with a corresponding plurality of individual cooking elements of the cooktop. Such exemplary method preferably may comprise creating a unique waveform corresponding with each respective individual knob whenever a respective individual knob is activated into its on position; combining all created unique waveforms into a single signal; and communicating the single signal to a controller, which determines from the single signal whether each of the plurality of individual knobs are activated.

Another example aspect of the present disclosure is directed to a method for detecting the respective positions of a plurality of respective switches associated with at least one individual control knob using AC input detection. Such exemplary method may preferably comprise associating with at least one individual control knob a plurality of respective switches which close when activated by the at least one individual knob; connecting each switch with a circuit which is in contact with an AC power input and which produces a unique waveform associated with each switch and its individual knob whenever activated into its on position by its at least one individual knob; combining all created unique waveforms into a single signal; and communicating the single signal to a controller, which determines from the single signal whether each of the plurality of respective switches are activated.

Another example aspect of the present disclosure is directed to a cooktop appliance, comprising a plurality of individual cooking elements, selectively operable to heat one or more loads; a corresponding plurality of individual knobs, respectively operatively associated with the plurality of individual cooking elements, for controllably switching the respective cooking elements when the knobs are in on or off positions thereof; a plurality of respective switches, respectively operably associated with each respective individual knob so that each respective switch closes when its respective individual knob is activated; a circuit associated with the plurality of respective switches and configured to produce a unique waveform corresponding with each switch and its respective individual knob whenever a respective individual knob is activated into its on position; a controller for the cooktop appliance; and a common node for inputting all producing unique waveforms as a single signal input to the controller. Preferably such controller is configured for detecting from the single signal input the respective positions of each of the plurality of individual knobs.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example representative cooking appliance according to example embodiments of the present disclosure;

FIG. 2 depicts a block diagram of an example control system for a cooking appliance according to example embodiments of the present disclosure;

FIG. 3 depicts an exemplary schematic diagram of a portion of an example heating system according to example embodiments of the present disclosure;

FIG. 4 depicts an exemplary schematic diagram of half of knob switches generally 400 and associated circuitry related to positive half cycle operations of presently disclosed subject matter;

FIG. 5 depicts exemplary graphical representations of various voltages associated with positive half cycle functionality of presently disclosed subject matter, particularly as represented in FIG. 4;

FIG. 6 depicts an exemplary schematic diagram of half of knob switches generally 400 and associated circuitry related to negative half cycle operations of presently disclosed subject matter;

FIG. 7 depicts exemplary graphical representations of various voltages associated with negative half cycle functionality of presently disclosed subject matter, particularly as represented in FIG. 6;

FIG. 8 depicts an example positive edge detection circuitry diagram according to example embodiments of the present disclosure;

FIG. 9 depicts an example negative edge detection circuitry diagram according to example embodiments of the present disclosure;

FIG. 10 depicts a graphical representation of an example output of example positive edge detection circuitry diagram of FIG. 8 according to example embodiments of the present disclosure;

FIG. 11 depicts a graphical representation of an example output of example negative edge detection circuitry diagram of FIG. 9 according to example embodiments of the present disclosure;

FIG. 12 depicts an example schematic circuit diagram implementation of respective positive and negative cycle outputs combined to a single output node according to example embodiments of the present disclosure; and

FIG. 13 depicts graphical representations of various example voltages associated with operation of FIG. 12, according to example embodiments of the present disclosure.

Repeat use of reference characters in the present specification and drawings is intended to represent the same and/or analogous features, elements, or steps of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

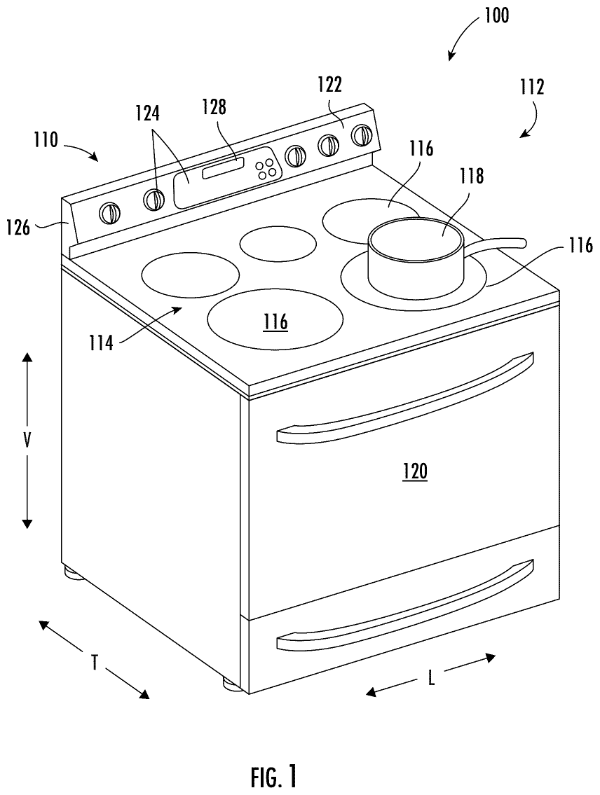

Referring now to the figures, FIG. 1 depicts a perspective view of an exemplary representative cooking appliance 100. Cooking appliance 100 is representative because it could represent an electric cooktop (such as using radiant heat) or a gas cooktop (such as using respective gas burners) or even an induction cooking appliance (such as using induction heating elements).

The representative cooking appliance includes a cooktop 112. The specific appearance of cooking appliance 100 is provided by way of example only and is not intended to limit the present subject matter to the arrangement shown in FIG. 1. Thus, the present subject matter may be used also with other cooking appliances such as oven appliances, single oven range appliances, double oven range appliances, standalone cooktop appliances, cooktop appliances without an oven, etc., in addition to being provided as several different types of cooktops.

Representative cooking appliance 100 generally defines a vertical direction V, a lateral direction L, and a transverse direction T, each of which is mutually perpendicular, such that an orthogonal coordinate system is generally defined. A cooking surface 114 of cooktop 112 includes a plurality of heating elements 116. Such elements may comprise such as burner coils, gas burners, induction heating elements, or other cooking-related features. Elements 116 are generally positioned at, e.g., on or proximate to, the cooking surface 114. Each element 116 may include one or more sub-elements to heat a load applied to the cooking element 116.

In the example of FIG. 1, cooktop 112 depicts five cooking or heating elements 116 spaced along cooking surface 114 for purposes of illustration only. Accordingly, cooktop 112 may include any other suitable shape, configuration, and/or number of heating elements 116. Each of the heating elements 116 may be resistive (radiant) or gas or induction heating elements 116, or cooktop 112 may include a combination of different types of heating elements 116. For example, in various embodiments, the cooktop 112 may include any other suitable type of heating elements 116 in addition to a resistive heating element, such as an induction heating element or gas burners, etc.

In some instances, a cooking zone may correspond to a volume of space in which a load is positioned to be heated by one or more heating elements 116. In some embodiments, cooktop 112 may have one or more flexible cooking zones corresponding to one or more of the heating elements 116. A flexible cooking zone may be adjusted to conform to the size and/or shape of an object (e.g., load). For instance, a load may be applied to a heating element 116. The flexible cooking zone of the heating element 116 may be adjusted based at least in part on one or more physical characteristics (e.g., size, shape, etc.) of the load applied to the flexible cooking zone such that the load may be heated. In some embodiments, the heating element 116 may include a plurality of sub-elements. Heat supplied via the sub-elements may be controlled to adjust the flexible cooking zone.

As shown in FIG. 1, a load 118 (e.g., cooking vessel), such as a pot, pan, or the like, may be placed on a heating element 116 to heat the load 118 and cook or heat food items placed in load 118. As will be described below in greater detail, each heating element 116 may include elements operable to heat a load 118. Cooking appliance 100 may also include a door 120 that permits access to a cooking chamber (not shown) of cooking appliance 100, e.g., for cooking or baking of food items therein. A user interface 122 (e.g., control panel) having controls 124 (e.g., user input devices) may permit a user to make selections for cooking of food items. Although shown on a backsplash or back panel 126 of cooking appliance 100, user interface 122 may be positioned in any suitable location. Controls 124 may include buttons, knobs, and the like, as well as combinations thereof, and/or controls 124 may be implemented on a remote user interface device such as a smartphone, tablet, etc. As an example, a user may manipulate one or more controls 124 to select a temperature and/or a heat or power output for each heating element 116. The selected temperature or heat output of heating element 116 affects the heat transferred to load 118 placed on heating element 116. The user interface 122 may also include a display 128.

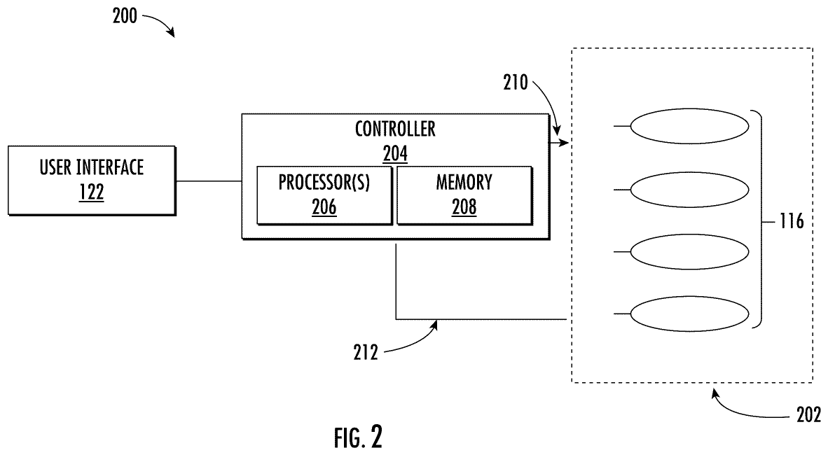

The cooking appliance 100 includes a control system for operably controlling one or more of the plurality of heating elements 116. Specifically, the control system may include a controller 204 (FIG. 2) operably coupled to the user interface 122 and the controls 124 and display 128 thereof. The controller may be operably coupled to each of the plurality of heating elements 116 for controlling a heating level each of the plurality of heating elements 116 in response to one or more user inputs received through the user interface 122 and controls 124. The controller may also provide output to the display 128, such as an indication of a selected power level, which heating element(s) 116 is or are activated, etc. Furthermore, as will be discussed in greater detail below, the control system may further be configured to (e.g., operable to) control operation of the heating system of the induction cooking appliance 100.

Referring now more fully to FIG. 2, a block diagram of a control system 200 (e.g., heating control system) for a cooking appliance 100 is provided. While control system 200 is discussed with reference to exemplary cooking system or appliance 100 of FIG. 1, those of ordinary skill in the art will understand that control system 200 may be used in any suitable cooking system without deviating from the scope of the present disclosure. Also, the presently disclosed subject matter more generally is compatible with any control that uses AC input detection.

As shown in FIG. 2, control system 200 includes a heating system 202 configured to (e.g., operable to) heat one or more loads (e.g., pans) which may be respectively associated with a plurality of heating elements 116. Specifically in the case of induction heating systems, inverters, switching devices, induction coils, and auxiliary load detection circuitry (not separately shown within dotted block diagram of system 202) may be provided as an induction heating system. More generally, elements 116 are operable to heat a load when supplied with appropriate energy, for example, such as an alternating current or lit gas flame.

Heating system 202 may receive power from a power supply circuit (not shown). The power supply circuit may include rectification circuitry for rectifying power from an alternating current (AC) supply, which may provide conventional 60 Hz 120 or 240 volt AC supplied by utility companies. In addition, the power supply circuit may include filtering and power factor correction circuitry to filter the power received.

In some embodiments, control system 200 further includes a controller 204 operatively coupled to or associated with each element 116 of the plurality of elements 116. Controller 204 may include one or more processors 206 such as microprocessors, CPUs or the like, such as general or special purpose microprocessors operable to execute programming instructions or micro-control code associated with memory 208, in conjunction with operational control of system 200. Memory 208 may represent random access memory such as DRAM, or read only memory such as ROM or FLASH. In one embodiment, the processor 206 executes programming instructions stored in memory 208. Memory 208 may be a separate component from controller 204 or may be included onboard controller 204.

Operational control over elements 116 is represented by line 210, the nature and extent of which may vary (as will be understood by those of ordinary skill in the art), depending in part on the nature of the elements 116. Specifically, for example, in the case of an induction heating system, controller 204 may be configured to (e.g., operable to) control the power of induction coils by controlling the switching frequency of associated inverters. For such purposes, controller 204 in such instances may include one or more microcontrollers and/or gate drivers to drive individual transistors or switching devices of associated inverters with pulse-width modulated signals.

In some embodiments, controller 204 is configured to (e.g., operable to) control one or more heating elements 116 based on a feedback loop 212. For example, in the case of an induction heating system, one or more coils associated with one or more elements 116 may be operated in a test mode, for example, to determine the load presented to each element 116. In other embodiments, the controller 204 may control one or more of the elements 116 based on feedback loop 212 indicating actual performance (for example, heating) accomplished by one or more of the elements 116.

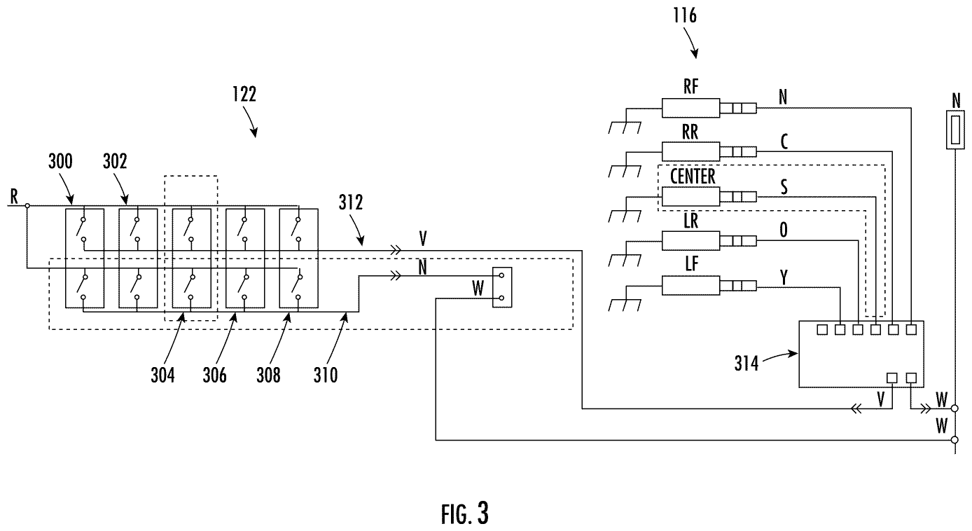

FIG. 3 depicts an exemplary schematic of a portion of an example heating system according to example embodiments of the present disclosure. While it will be understood that different heating systems may be practiced, such as radiant heat, gas burners, and/or induction heating, with various numbers of burners, FIG. 3 depicts in particular a representation of a five burner, gas burner configuration. In particular, a plurality of switches are represented in a user interface 122 configuration, interactive with a representative controller feature 314, which in turn is operably associated with a plurality (for example, five) elements (respective igniters for respective gas burners) 116. The exemplary five burners may be arranged in different configurations, with the examples shown designated as RF (right front), RR (right rear), CENTER, LR (left rear), and LF (left front), operatively associated respectively with controller 314 via respective lines designated N, C, S, O, and Y, as shown. In some examples, 314 may comprise a so-called spark block, which is a small device that contains the coils that generates the high voltage to break the air gap at the igniters and generate the spark that ignites the gas in the burner.

As further depicted in FIG. 3, five respective “knobs” 300, 302, 304, 306, and 308 each have and operate a pair of switches. As shown, the “knobs” effectively comprise two respective sets of five switches which are in parallel to facilitate performing two different functions. One set of the switches (the bottom set in FIG. 3) are involved with detecting the AC input to the micro controller within exemplary block 314 via common line 310. The other set of switches (the top set of switches in FIG. 3) is used to send a signal via line 312 to the spark module for gas cooktops so they know to engage the igniter, which signal is L1 supplied to the block/module 314 (and which signal is manipulated per presently disclosed subject matter to determine which knob is active).

The top set of switches associated with common line 312 is only closed when the associated knob is in the “lite” position, in this exemplary embodiment involving gas burners as heating elements 116. The bottom set of switches associated with common line 310 for sensing the AC input is in the closed position any time the knob is not in the OFF position.

Stated another way, each pair of switches enclosed in each rectangle are within the same knob. The top switch from each pair connects via line 312 a line voltage of the system to a spark block associated with block 314, which enables in this exemplary embodiment the spark to ignite an associated gas burner. The bottom switch is just connecting the line voltage of the system to the knob signal via line 310 to a different input W associated with controller 204. It is the signal on such line 310 that is being changed from an AC sinusoidal shape to a pulsing signal per presently disclosed subject matter that will help the microcontroller within or associated with controller 204 to identify which respective knob is active. W indicates “White” to identify the wiring color for the neutral signal in the presently disclosed system. The small rectangle associated to controller 204 connects on pin 1 the signal, and it closes the internal circuit through an optocoupler input to Neutral.

The presently disclosed subject matter allows for the detection of individual knobs of a cooktop to be detected. In exemplary embodiments, the presently disclosed subject matter utilizes a knob activated switch that is connected in series with a 120 VAC source from the wall. When the switch is in the closed position, the switch connects to a circuit utilizing a Zener diode in order to clip the 120 VAC waveform based off of the Zener voltage of the diode. By utilizing different Zener voltages, it is possible to create multiple unique waveforms corresponding to each knob input.

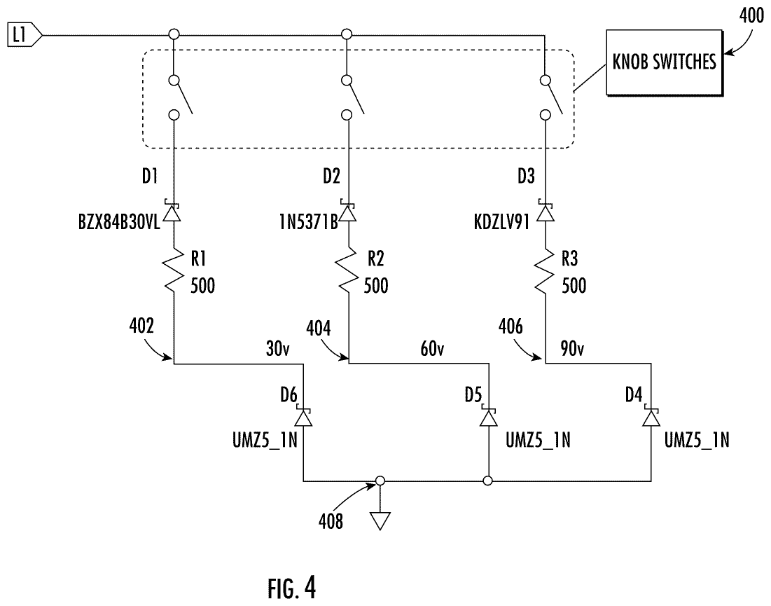

The exemplary circuit schematic shown in FIG. 4 is for an exemplary six knob system, utilizing three Zener diodes on the positive half cycle. However, in general, any number of knobs could be detected utilizing additional Zener diodes, each with their own respective distinct Zener voltages.

In general, FIG. 4 depicts an exemplary schematic diagram of half of knob switches generally 400 and associated circuitry related to positive half cycle operations of presently disclosed subject matter. In particular, knob switches 400 are connected with representative line voltage L1 and six Zener diodes D1, D2, D3, D4, D5, and D6, respectively. When the AC sinusoidal waveform generated from L1 is above the Zener voltage, the Zener diode begins conducting and allows current through the resistor (R1/R2/R3). Another Zener is then located after each resistor to clip the voltage across D4/D5/D6 to a lower voltage, which circuitry comprises a clipping circuit.

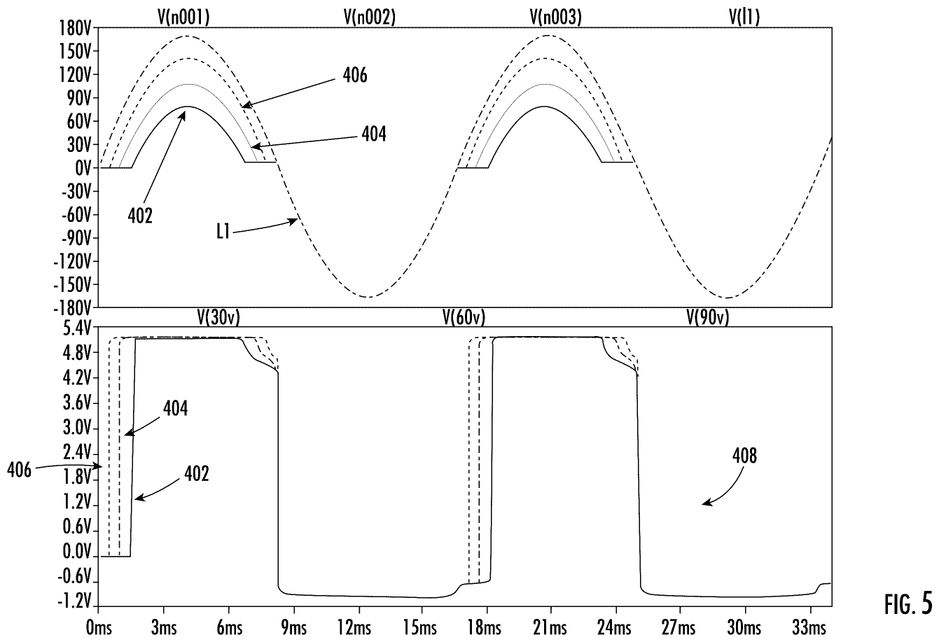

FIG. 5 depicts voltage traces, reflecting various circuit outputs from the exemplary circuitry of FIG. 4. Nodes 402, 404, and 406 of FIG. 4 indicate respective outputs of Zener diodes D1, D2, and D3 as output through resistors R1, R2, and R3. Assuming the switches of FIG. 4 are closed, then the upper traces of FIG. 5 represent the voltage traces of L1, and the positive voltage traces of nodes 402, 404, and 406, respectively. The lower traces of FIG. 5 represent the superimposed voltage outputs 402, 404, and 406, as present at common node 408, after passing through the clipping circuitry involving Zener diodes D4, D5, and D6. The resulting lower traces of FIG. 5 exhibit leading edges as respective different time events because they are determined by the different rise slopes of the voltage traces 402, 404, and 406 respectively of the upper traces of FIG. 5.

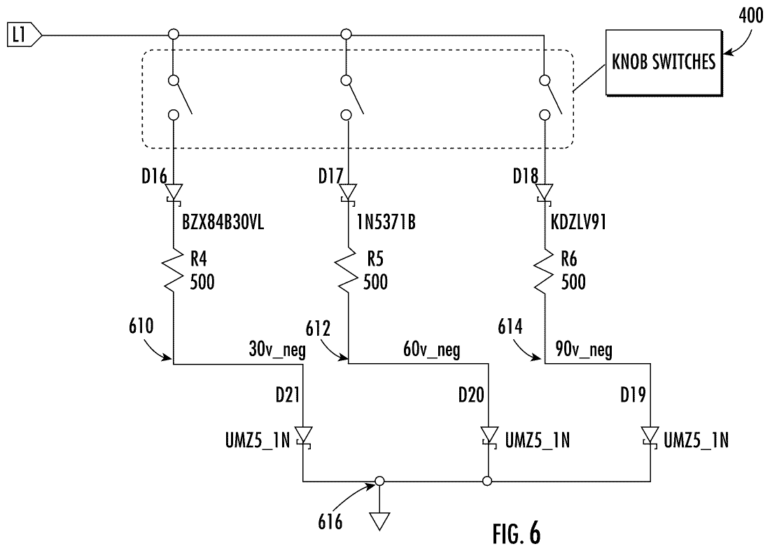

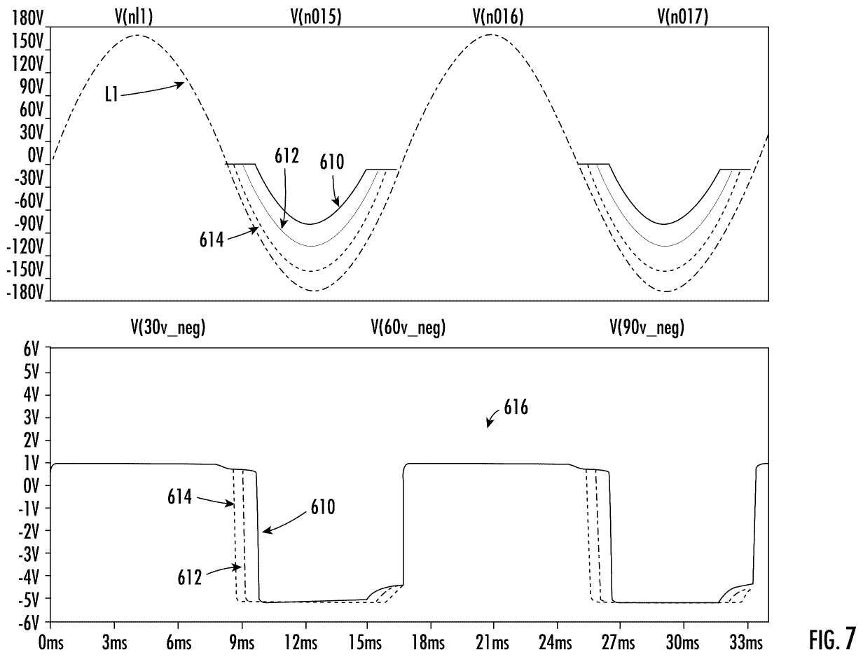

FIGS. 4 and 5 relate to presently disclosed subject matter involving positive half cycle aspects of L1 and the related and/or derived voltages. In contrast, FIGS. 6 and 7 relate to presently disclosed subject matter involving negative half cycle aspects of L1 and the related and/or derived voltages. FIG. 6 depicts an exemplary schematic diagram of half of knob switches generally 400 and associated circuitry related to negative half cycle operations of presently disclosed subject matter. Thus, the three represented switches of FIG. 6 (half of knob switches 400) represent preferably three different switches from the three represented in FIG. 4, for a total of six switches in this exemplary embodiment. As depicted, all Zener diodes of FIGS. 4 and 5 have the opposite polarity senses as those depicted in FIGS. 6 and 7, so that collectively both positive and negative half cycles are subject to the presently disclosed subject matter.

Similar to FIG. 4, FIG. 7 depicts voltage traces, reflecting various circuit outputs from the exemplary circuitry of FIG. 6. Nodes 610, 612, and 614 of FIG. 6 indicate respective outputs of Zener diodes D16, D17, and D18 as output through resistors R4, R5, and R6. Assuming the switches of FIG. 6 are closed, then the upper traces of FIG. 7 represent the voltage traces of L1, and the negative voltage traces of nodes 610, 612, and 614, respectively. The lower traces of FIG. 7 represent the superimposed voltage outputs 610, 612, and 614, as present at common node 616, after passing through the clipping circuitry involving Zener diodes D21, D20, and D19. The resulting lower traces of FIG. 7 exhibit leading edges as respective different time events because they are determined by the different fall slopes of the voltage traces 610, 612, and 614 respectively of the upper traces of FIG. 7.

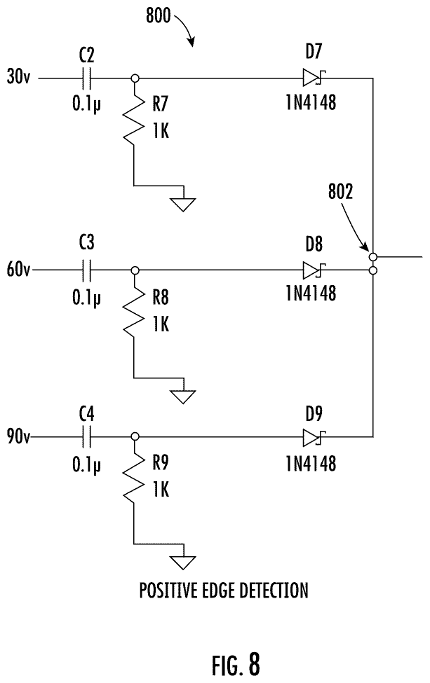

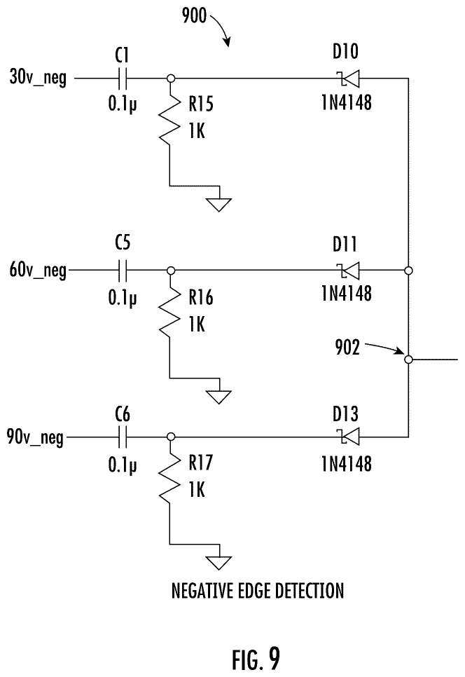

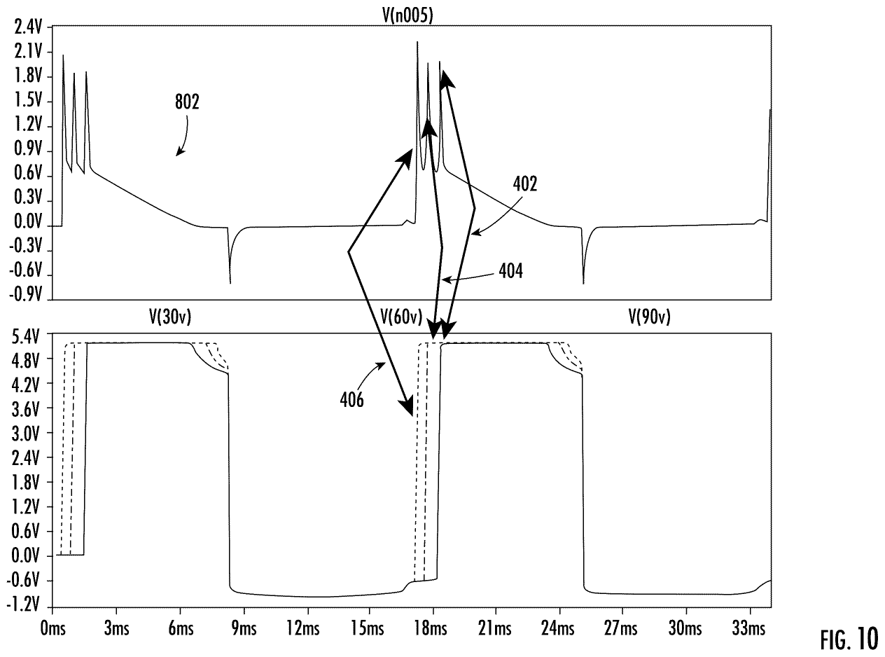

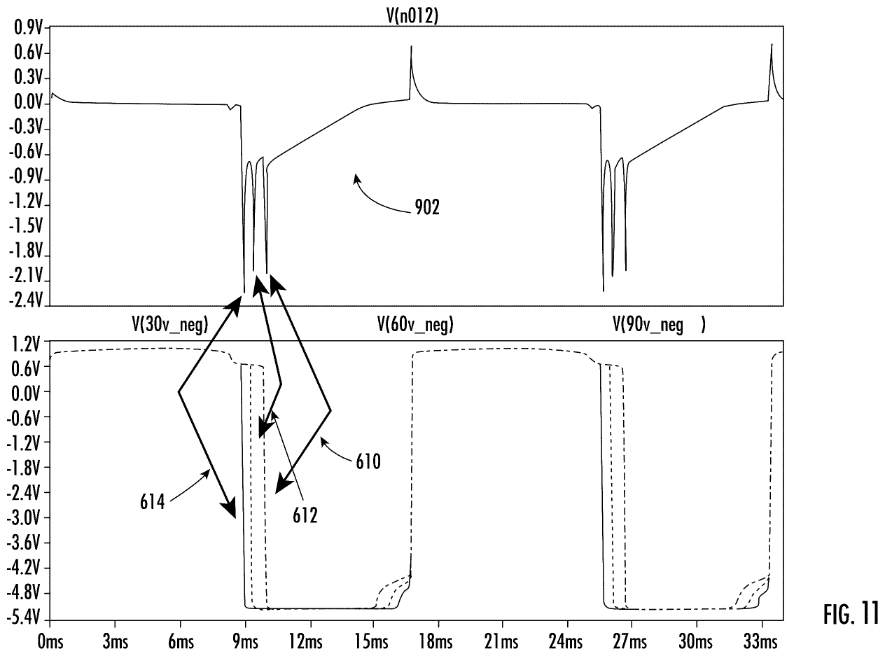

After the waveform from each Zener has been conditioned to a lower voltage, the final step is to send the waveform through a positive or negative edge detection circuit. This sends only a single pulse through when either a positive or negative edge of the waveform occurs. The positive edge detection is used for the Zener diodes that act on the positive half cycle and the negative edge detection is used for the Zener diodes that act on the negative half cycle. An example circuit diagram is shown in FIGS. 8 and 9, respectively, for positive and negative edge detection. FIGS. 10 and 11 depict graphs which respectively illustrate example voltages from such as example circuits 800 and 900 depicted in FIGS. 8 and 9, respectively, in accordance with presently disclosed subject matter.

The output from the edge detection circuitry 800 or 900 can then be tied to a single node at its respective output, which allows for each pulse to be read on a single signal separated in time. For example, considering positive edge detection features, FIG. 8 depicts respective Zener diodes D7, D8, and D9, each respectively associated with resistor/capacitor inputs coupled between a voltage level input (30V, 60V, or 90V, respectively) and ground. As otherwise referenced herein, different voltages levels and different numbers of voltages levels and respective spacing therebetween may be practiced within the spirit and scope of the presently disclosed subject matter. Such variations may be practiced in either or both of the positive and negative half cycles of operation.

For the presently illustrated exemplary embodiment of FIG. 8, all of the outputs of Zener diodes D7, D8, and D9 are tied to single node 802. It should be noted that the bottom half traces of FIG. 10 repeat the bottom half traces of FIG. 5 as otherwise described herein. As otherwise represented in FIG. 10, the detected leading edges of traces 406, 404, and 402 respectively are translated and combined by the example positive edge detection circuit 800 of FIG. 8 into the composite single signal 802 output from circuit 800.

Considering exemplary corresponding negative edge detection features, FIG. 9 depicts respective Zener diodes D10, D11, and D13, each respectively associated with resistor/capacitor inputs coupled between a voltage level input (−30V, −60V, or −90V, respectively) and ground. All of the outputs of Zener diodes D10, D11, and D13 are tied to single node 902. It should be noted that the bottom half traces of FIG. 11 repeat the bottom half traces of FIG. 7 as otherwise described herein. As otherwise represented in FIG. 10, the detected leading edges of traces 610, 612, and 614 respectively are translated and combined by the example positive edge detection circuit 900 of FIG. 8 into the composite single signal 902 output from circuit 900.

The output from the presently disclosed edge detection functionality can be tied to a single node at the output, which allows for each pulse to be read on a single signal separated in time. That amounts to potentially six respective pulses in the six knob exemplary embodiment presented in conjunction with the presently disclosed subject matter. Of course, the presently disclosed subject matter is not limited to a six knob solution, per the exemplary only embodiment included in this specification.

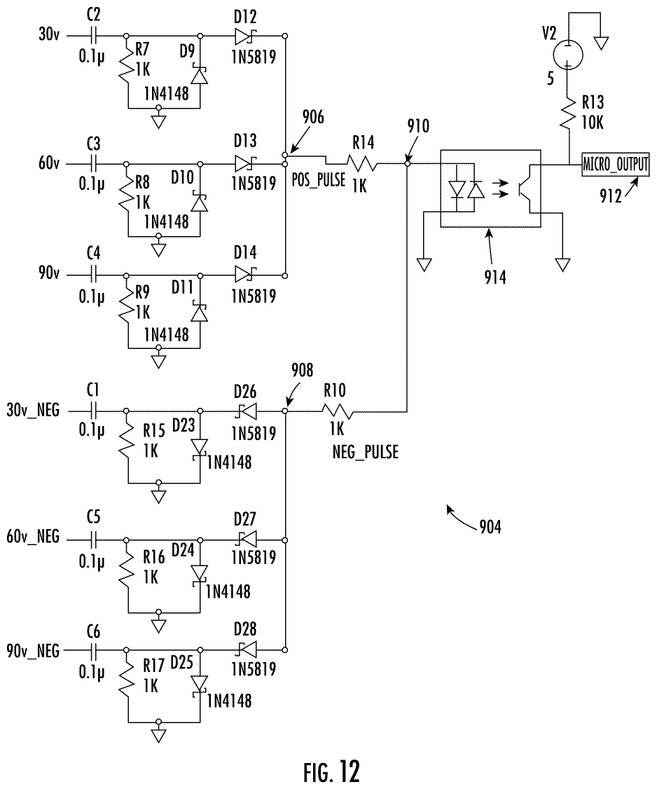

As further example, FIG. 12 depicts an exemplary six knob circuit diagram generally 904 which has respective positive and negative cycle outputs 906 and 908 which are combined through exemplary respective output resistors R14 and R10 to a single output node 910. Single output node 910 is input into a microcontroller, which then provides a representative Micro_Output 912, as depicted in FIG. 12. As also depicted in FIG. 12, the input to a microcontroller can be isolated for safety and to satisfy potentially applicable regulations, such as through use of an optocoupler generally 914. Thus, pulses tied to optocoupler 914 create distinct pulses both for the positive half cycle pulses and negative half cycle pulses. Other techniques for input isolation may be practiced, either existing now or later developed.

As an alternative for some presently disclosed embodiments, a non-isolated implementation may be practiced. For example, instead of pulses going into the input of an optocoupler, the pulses could also drive a transistor to send pulses to the microcontroller. Such solution would work for example for a control that is line referenced and does not require electrical isolation.

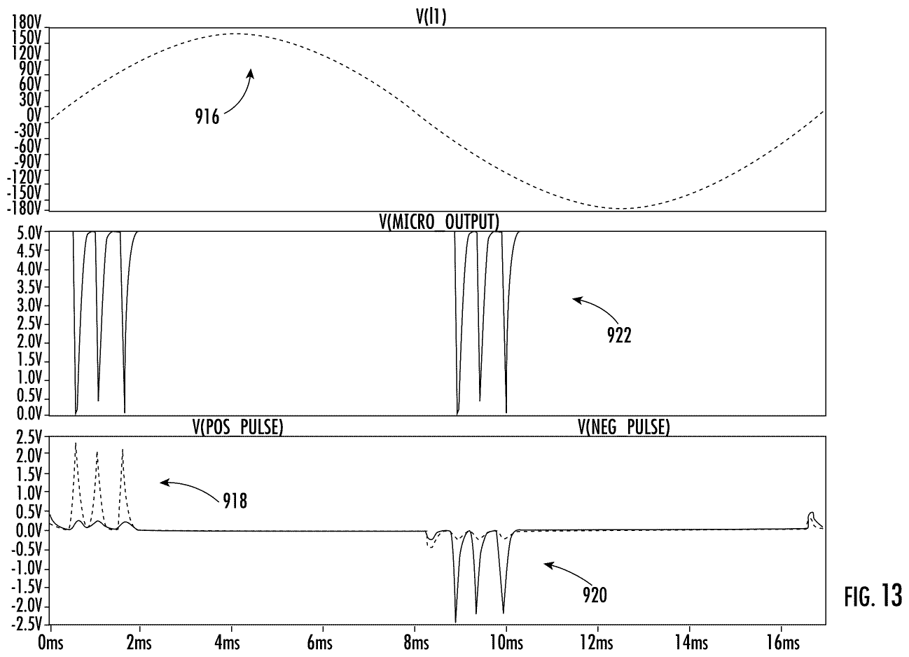

Internally utilizing a zero cross circuit, a microcontroller can read 6 independent signals on a single signal input simultaneously, and can know which pulses correspond with which knob. As will be understood from the complete disclosure herewith, the presently disclosed subject matter is not limited to the use of six signals, and can be adjusted to other numbers of signals. For example, using multiple different voltage Zener diodes, the subject matter can readily be expanded by those of ordinary skill in the art from the present disclosure to more input numbers. FIG. 13 represents multiple voltage traces associated with operation and functionality of an exemplary microcontroller. For example, trace 916 represents original line voltage L1 from which the microcontroller can determine zero crossings, three of which are represented by the top trace of FIG. 13. The bottom two traces 918 and 920 of FIG. 13 represent pos_pulse and neg_pulse inputs of FIG. 12 from nodes 906 and 908 of circuit 904.

FIG. 13 further depicts the association of a 5V comparison for Micro_Output 912. As understood generally from digital electronics, “1's” and “0's” may be typically associated with respective voltage levels of 5V and 0V. The middle trace 922 of FIG. 13 illustrates the Micro_Output 912 with a “constant” “1” or 5V output, interrupted at designated time intervals of a full 360 degree cycle of L1 (trace 916) by six “0” signal indications. Based on the time intervals of those occurrences relative to the zero cross detections, the microcontroller can determine which of the exemplary six knobs are in an “on” position. Again, the use of six is only exemplary, and not limiting.

For purposes of the present example and its corresponding discussion and explanation, all knobs are switched into an “on” position. Those of ordinary skill from the complete disclosure herewith will understand that if one or more of the six indicated “0” detections (close to 0V) of trace 922 are “missing” so that the trace 922 reads 5V (“1”) during that corresponding time segment in the full cycle of trace 916, it means that the corresponding knob(s) is in its “off” position. Therefore, the presently disclosed subject matter allows for the detection of any combination of knobs and to know which specific knobs are on at the same time.

The presently disclosed subject matter generally has a number of specific benefits. For example, exemplary circuitry needed to manipulate the input signal is small enough that it can fit easily within the knob harnessing, resulting desirably in small form factor. From a cost perspective, there are significantly reduced costs. For example, the added functionality presently disclosed via a single signal has low-cost impact on the overall design since it only requires a single input wire for all knobs and only requires a single input to the final microcontroller.

The presently disclosed subject matter is equally applicable to a variety of appliances, for example, gas cooking ranges, electric cooking ranges, or dual fuel cooking ranges. It should be further understood that the presently disclosed subject matter is not limited in use to just a knob system for an appliance. For any system where an AC input detection is required, the presently disclosed subject matter could be implemented to allow all AC inputs for a system to be read on a single input. For example, multiple relay outputs (or any AC load) could be monitored on a single input.

The presently disclosed subject matter also provides high compatibility or even potentially retro-fitting relative to existing implementations. For example, the presently disclosed subject matter can be implemented in a knob harness that can replace an existing implementation and still be compatible, just requiring some changes in associated microcontroller software, to use signal timing to identify the active knob(s) using the same input.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for detecting the respective positions of a plurality of individual knobs of a cooktop, which plurality of individual knobs are operatively associated with a corresponding plurality of individual cooking elements of the cooktop, comprising:
creating a unique waveform corresponding with each respective individual knob whenever a respective individual knob is activated into its on position;
combining all created unique waveforms into a single signal; and
communicating the single signal to a controller, which determines from the single signal whether each of the plurality of individual knobs are activated.

2. The method of claim 1, wherein creating a unique waveform further comprises:
associating with each respective individual knob a respective switch which closes when its respective individual knob is activated; and
connecting each switch with a circuit which produces a unique waveform associated with each switch and its respective individual knob.

3. The method of claim 2, wherein each switch is connected with a circuit utilizing a Zener diode to clip input power voltage based on the corresponding Zener voltage of the Zener diode.

4. The method of claim 3, further comprising using different Zener voltages for different respective individual knobs, to create multiple clipped waveform outputs corresponding to each respective individual knob input.

5. The method of claim 4, further comprising:
respectively conditioning the multiple clipped waveform outputs to a voltage range lower that the input power voltage;
conducting edge detection on the conditioned multiple clipped waveform outputs; and
combining the edge detections into a single signal output.

6. The method of claim 5, wherein edge detection comprises conducting positive edge detection for the Zener diodes that act on the positive half cycle of the input power voltage and conducting negative edge detection for the Zener diodes that act on the negative half cycle of the input power voltage.

7. The method of claim 5, wherein:
the controller comprises a microcontroller;
the single signal output is input to the microcontroller; and
the microcontroller identifies the respective individual knobs which are activated based on comparing the single signal relative to zero crossing determinations of the input power voltage.

8. The method of claim 1, wherein the individual cooking elements comprise at least one of electric radiant heat elements, gas burners, and induction heating elements.

9. The method of claim 7, wherein the single signal output is input to the microcontroller via an optocoupler.

10. The method of claim 1, wherein the plurality of individual cooking elements of the cooktop include in a range from two to ten individual cooking elements and a corresponding plurality of individual knobs.

11. A cooktop appliance, comprising:
a plurality of individual cooking elements, selectively operable to heat one or more loads;
a corresponding plurality of individual knobs, respectively operatively associated with the plurality of individual cooking elements, for controllably switching the respective cooking elements when the knobs are in on or off positions thereof;
a plurality of respective switches, respectively operably associated with each respective individual knob so that each respective switch closes when its respective individual knob is activated;
a circuit associated with the plurality of respective switches and configured to produce a unique waveform corresponding with each switch and its respective individual knob whenever a respective individual knob is activated into its on position;
a controller for the cooktop appliance; and
a common node for inputting all producing unique waveforms as a single signal input to the controller;
wherein the controller is configured for detecting from the single signal input the respective positions of each of the plurality of individual knobs.

12. The cooktop appliance of claim 11, wherein the circuit comprises a plurality of Zener diodes, with one Zener diode each respectively connected with each switch to clip input power voltage based on the corresponding Zener voltage of the Zener diode, wherein the plurality of Zener diodes have different Zener voltages for different respective individual knobs, to create multiple clipped waveform outputs corresponding to each respective individual knob input.

13. The cooktop appliance of claim 12, further comprising an edge detection circuit configured for conducting edge detection on the conditioned multiple clipped waveform outputs, and combining the edge detections into a single signal output.

14. The cooktop appliance of claim 13, wherein the edge detection circuit is further configured for conducting positive edge detection using Zener diodes that are configured for acting on the positive half cycle of the input power voltage and configured for conducting negative edge detection using Zener diodes that are configured for acting on the negative half cycle of the input power voltage.

15. The cooktop appliance of claim 11, wherein the controller comprises a microcontroller executing programming instructions for identifying the respective individual knobs which are activated based on comparing the single signal relative to zero crossing determinations of the input power voltage.

16. The cooktop appliance of claim 11, further comprising an optocoupler for coupling the common node and the controller.

17. The cooktop appliance of claim 11, wherein:
the individual cooking elements comprise at least one of electric radiant heat elements, gas burners, and induction heating elements; and
the plurality of individual cooking elements of the cooktop comprise a range from two to ten individual cooking elements and a corresponding plurality of individual knobs.

18. A method for detecting the respective positions of a plurality of respective switches associated with at least one individual control knob using AC input detection, comprising:
associating with at least one individual control knob a plurality of respective switches which close when activated by the at least one individual knob;
connecting each switch with a circuit which is in contact with an AC power input and which produces a unique waveform associated with each switch and its individual knob whenever activated into its on position by its at least one individual knob;
combining all created unique waveforms into a single signal; and
communicating the single signal to a controller, which determines from the single signal whether each of the plurality of respective switches are activated.

19. The method of claim 18, further comprising:
providing a plurality of respective control knobs, each having at least one respective switch which closes when its respective individual knob is activated;
connecting each switch with a circuit utilizing a Zener diode to clip input power voltage based on the corresponding Zener voltage of the Zener diode; and
using different Zener voltages for different respective individual knobs, to create multiple clipped waveform outputs corresponding to each respective individual knob input;
conducting edge detection on the multiple clipped waveform outputs; and
combining the edge detections into the single signal output.

20. The method of claim 19, further comprising:
providing a plurality of individual cooking elements of a cooktop appliance, selectively operable by the corresponding plurality of individual knobs to heat one or more loads;
wherein the controller comprises a microcontroller;
the single signal output is input to the microcontroller; and
the microcontroller identifies the respective individual knobs which are activated based on comparing the single signal relative to zero crossing determinations of the input power voltage.
